(19) United States
(12) Patent Application Publication
(10) Pub. No.: US 2021/0030170 A1
(43) Pub. Date: Feb. 4, 2021

(54) RETAIL DISPLAY FIXTURE

(71) Applicant: LULULEMON ATHLETICA CANADA INC., Vancouver (CA)

(72) Inventors: Aaron ROSENSWEET, Vancouver (CA); James Budhram MONTGOMERY, Vancouver (CA)

(21) Appl. No.: 16/526,469

(22) Filed: Jul. 30, 2019

(51) Int. Cl. A47F 5/13; A47F 5/08; G09F 15/00

(52) U.S. Cl. CPC A47F 5/13; A47F 5/0846; G09F 2007/1843; G09F 15/0012; G09F 15/0068

(57) ABSTRACT

The current invention relates to an adjustable retail display fixture. The adjustable retail display fixture includes at least one track operably configured to be attached to a wall and a display structure slidably engaged with the at least one track. The display structure includes first and second telescoping vertical arms and may also include at least one horizontal bar extending therebetween. Each of the first and second telescoping vertical arms include a plurality of bars nested one into another and connected with one or more releasable fasteners. A height of the display structure is adjustable by adjusting the position of each of the first and second plurality of bars with respect to another using the one or more releasable fasteners to adjust the length of the first and second telescoping vertical arms, respectively.

### TECHNICAL FIELD

The present disclosure relates to a retail display fixture. More specifically, the present disclosure relates to a retail display fixture operably configured to be attached to a wall with both an adjustable height and width.

### BACKGROUND

Retail businesses typically use a wide variety of display systems and articles to draw consumer attention to the products being sold. The display systems help the consumer envision how the product will look when worn, used, assembled, etc. Conventional display systems often incorporate the product itself to help the consumer envision use or wear of the product. Stores often have pegboard walls, slot walls, and/or wire grid walls for supporting and displaying merchandise in addition to various floor fixtures on which merchandise may be placed or hung for display. For example, many retailers display their goods by hanging them on aisle display walls or positioning them on shelves carried by the display walls or fixtures. Since such walls do not normally extend higher than the viewing or reaching height of the purchasers, the retailer often desires to place signage above the wall to describe or otherwise promote the products being displayed on the wall.

Typically, a retail space will include a diverse range of product-display fixtures. Arrangement of such fixtures often follows a set of tactics for ensuring that a maximum number of shoppers will see and actively consider purchasing a displayed product or merchandise. It is well known that specific prime locations within a retail floor space are highly desirable for generation of sales. Similarly, certain locations within, and/or on, display fixtures are known to produce higher sales volumes. A principal need of many retailers is to maximize the quantity of products displayed within a given floor area, and more specifically, to maximize the display of products with the highest sales volumes, cash values and profit margins within the prime store locations. For this and other reasons, it is economically important to utilize the maximum amount of available product display space within a store.

Furthermore, retailers require flexibility in displaying products and merchandise, and controlling inventory within the product display system. Currently, a large number of retailers rely on cumbersome, industry standard, retail display systems that allow only limited flexibility in arrangement, ease of modification and product-specific display. Many retailers create relatively static, permanent displays; however, not all products merit such long-term placement. For example, products may not be in high demand or are seasonal and have a relatively short promotional window. It is highly desirable that product placement systems are easy to modify and provide a high degree of adaptability to quickly change marketing strategies and inventory management solutions. Currently, many retailers use a variety of add-on merchandising displays in conjunction with existing conventional shelving construction to increase product display densities.

However, the foregoing systems suffer from drawbacks. For example, many display systems are made with flimsy construction that may be easily dislodged or removed from its supports. Further, such merchandising systems are limited in their adaptability to a diverse range of packaging, product lines, display quantities and shelving types, and many merchandising systems provide limited opportunities for supplementary advertising and product “branding”. Thus, there remains a need for a system to display signage and products which is stable, can carry a variety of shelving types, and is height and width adjustable.

### SUMMARY

In one aspect, an adjustable retail display fixture is provided. The adjustable retail display fixture comprises at least one track, the at least one track operably configured to be attached to a wall; and a display structure slidable along a length of the at least one track and slidably engaged therewith. The display structure comprises a first plurality of bars nested one into another forming a first telescoping vertical arm with a first end, a second end and a length, each of the first plurality of bars connected to another with one or more releasable fasteners, the one or more releasable fasteners holding a position of each of the first plurality of bars with respect to another; and a second plurality of bars nested one into another forming a second telescoping vertical arm with a first end, a second end and a length, each of the second plurality of bars connected to another with one or more releasable fasteners, the one or more releasable fasteners holding a position of each of the second plurality of bars with respect to another. A height of the display structure is adjustable by adjusting the position of each of the first plurality of bars with respect to another using the one or more releasable fasteners to adjust the length of the first telescoping vertical arm and by adjusting the position of each of the second plurality of bars with respect to another using the one or more releasable fasteners to adjust the length of the second telescoping vertical arm. In various embodiments, one or more than one display structure is slidably engaged with the at least one track.

In another aspect, a display structure for an adjustable retail display fixture is provided. The display structure comprises a first plurality of bars nested one into another forming a first telescoping vertical arm with a first end, a second end and a length, each of the first plurality of bars connected to another with one or more releasable fasteners, the one or more releasable fasteners holding a position of each of the first plurality of bars with respect to another; and a second plurality of bars nested one into another forming a second telescoping vertical arm with a first end, a second end and a length, each of the second plurality of bars connected to another with one or more releasable fasteners, the one or more releasable fasteners holding a position of each of the second plurality of bars with respect to another. A height of the display structure is adjustable by adjusting the position of each of the first plurality of bars with respect to another using the one or more releasable fasteners to adjust the length of the first telescoping vertical arm and by adjusting the position of each of the second plurality of bars with respect to another using the one or more releasable fasteners to adjust the length of the second telescoping vertical arm.

The display structure may further comprise at least one horizontal bar having a length and attached to the first telescoping vertical arm and the second telescoping vertical arm and extending therebetween. For example, the at least one horizontal bar may be reversibly attached to the second ends of the first and second telescoping vertical arms. The at least one horizontal bar may comprise at least two bars nested one into another and connected to another with one or more releasable fasteners. In other embodiments, the at least one horizontal bar is of static length and the height of the di splay structure is adjustable.

The display structure may further comprise at least one carrying element attached to the first telescoping vertical arm and the second telescoping vertical arm and extending therebetween. The carrying element may be a shelf, a hanger rod or a marketing display.

The first and second telescoping vertical arms may each comprise two bars nested one into another and connected with one releasable fastener.

The first end of the first telescoping vertical arm and the first end of the second telescoping vertical arm may each comprise a lockable rail element slidably engaged with the at least one track. For example, the at least one track may comprise first and second tracks and the display structure further comprises a panel attached to the first ends of the first and second telescoping vertical arms and extending therebetween, the panel comprising at least two perpendicular cross-arms having first and second ends, the first and second ends of the at least two cross-arms each comprising a lockable rail element, the lockable rail elements of the first ends slidably engaged with the first track and the lockable rail elements of the second ends slidably engaged with the second track. For example, the lockable rail elements may comprise lockable wheels.

In various embodiments, the one or more releasable fasteners comprise one or more releasable locking pins or locking bolts and each rod of the first and second plurality of rods comprises a plurality of holes along a length of the rod for engaging the one or more releasable locking pins.

In addition to the aspects and embodiments described above, further aspects and embodiments will become apparent by reference to the drawings and study of the following detailed description.

### BRIEF DESCRIPTION OF THE DRAWINGS

These and other features of the present disclosure will become more apparent from the following description in which reference is made to the appended drawings:

FIG. 1 is a perspective view of an adjustable retail display fixture according to an embodiment of the invention.

FIG. 2 is a front view of an adjustable retail display fixture according to an embodiment of the invention.

FIG. 3 is a side view of a lockable rail element slidably engaged with at least one track of an adjustable retail display fixture according to an embodiment of the invention.

FIG. 4 is an exploded view of a display structure of an adjustable retail display fixture according to an embodiment of the invention.

### DETAILED DESCRIPTION

The present disclosure relates to an adjustable retail display fixture. The display fixtures disclosed herein comprise at least one track, the at least one track operably configured to be attached to a wall. The display fixture also comprises a display structure slidable along a length of the at least one track and slidably engaged therewith. The display structure may be easily positioned anywhere along the length of the track and is adjustable both in height and width. Thus, the design and layout of a retail space may be re-designed and changed easily and efficiently. Furthermore, by attaching the retail display fixture to a wall, such as a ceiling, less floor space is used by the supporting structure of the retail display fixture, allowing for increased display of products and merchandise.

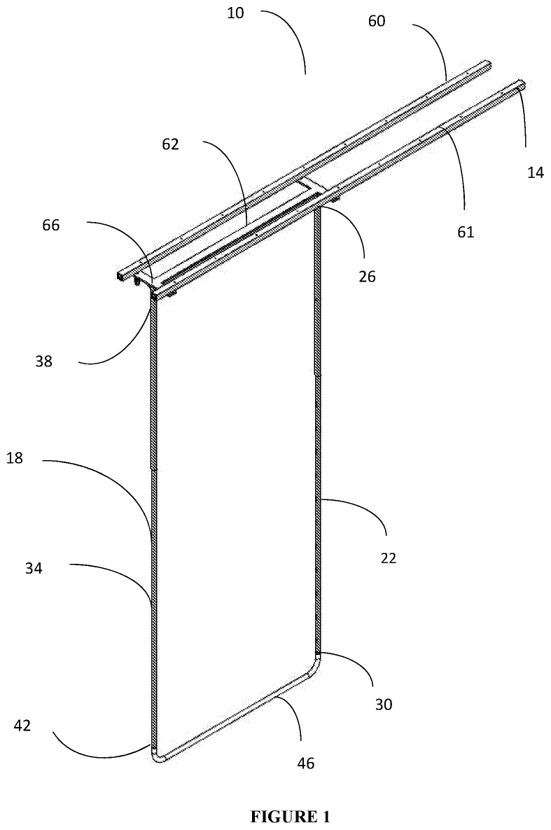

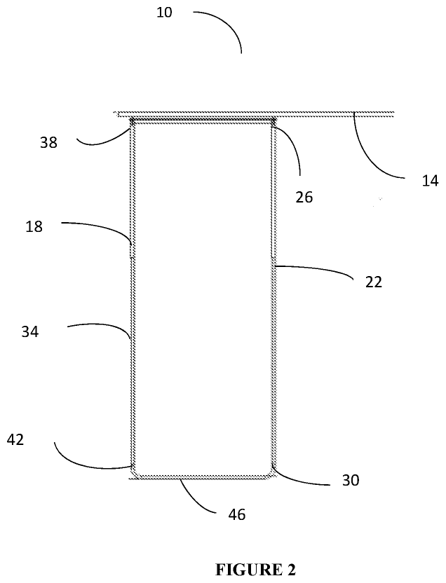

An embodiment of an adjustable retail display fixture as disclosed herein is shown in FIG. 1. A front view of the same embodiment is shown in FIG. 2. Adjustable retail display fixture 10 comprises at least one track 14 and a display structure 18. Display structure 18 is slidable along a length of the at least one track 14 and is slidably engaged therewith. In the embodiment shown in FIGS. 1 and 2, the at least one track is operably configured to be attached to a ceiling of a retail space and the display structure hangs therefrom. In other embodiments of the invention, the display structure is operably configured to be attached to a side wall or to a floor of a retail space.

The display structure 18 comprises a first plurality of bars nested one into another forming a first telescoping vertical arm 22 with a first end 26, a second end 30 and a length. Each of the first plurality of bars is connected to another with one or more releasable fasteners, the one or more releasable fasteners holding a position of each of the first plurality of bars with respect to another. For example, the first telescoping vertical arm 22 may comprise two bars nested one into another and connected with one releasable fastener. For example, the one or more releasable fasteners may comprise one or more releasable locking pins or locking bolts and each rod of the first plurality of rods comprises a plurality of holes along a length of the rod for engaging the one or more releasable locking pins or locking bolts.

The display structure 18 also comprises a second plurality of bars nested one into another forming a second telescoping vertical arm 34 with a first end 38, a second end 42 and a length. Each of the second plurality of bars is connected to another with one or more releasable fasteners, the one or more releasable fasteners holding a position of each of the second plurality of bars with respect to another. For example, the one or more releasable fasteners may comprise one or more releasable locking pins or locking bolts and each rod of the second plurality of rods comprises a plurality of holes along a length of the rod for engaging the one or more releasable locking pins or locking bolts.

The first and second plurality of bars may be made of any suitable material, such as, for example, a plastic, a composite material, a metal, a plastic with a coating or finish, or a metal with a coating or finish.

Various embodiments of the display structure may also comprise at least one horizontal bar 46 having a length that is attached to the first telescoping vertical arm 22 and the second telescoping vertical arm 34 and extends therebetween. The at least one horizontal bar 46 may have a fixed length, as shown in FIGS. 1 and 2, and be reversibly attached to the second ends 30 and 42 of the first and second telescoping vertical arms, respectively. Alternatively, the at least one horizontal bar may comprise at least two bars nested one into another and connected to another with one or more releasable fasteners. In various embodiments, the at least one horizontal bar 46 may act as a carrying element, such as a hanger, in order to display products or merchandise, such as, for example, clothing.

A height of the display structure 18 is adjustable by adjusting the lengths of the first telescoping vertical arm 22 and the second telescoping vertical arm 34. For example, the height of the display structure is adjustable by adjusting the position of each of the first plurality of bars with respect to another using the one or more releasable fasteners to adjust the length of the first telescoping vertical arm 22 and by adjusting the position of each of the second plurality of bars with respect to another using the one or more releasable fasteners to adjust the length of the second telescoping vertical arm 34.

A width of the display structure 18 may be adjusted by adjusting the position of the first and second vertical arms 22 and 34 one in respect to the other by, for example, sliding the vertical arms along the at least one track and then locking the first and second telescoping vertical arms into position. If the display structure includes the at least one horizontal bar 46, the width of the display structure 18 may also be adjusted by adjusting the length of the at least one horizontal bar 46. For example, if the at least one horizontal bar comprises at least two bars nested one into another to connected to another with one or more releasable fasteners, the width of the display structure may be adjusted by adjusting the position of each of the at least two bars with respect to another using the one or more releasable fasteners.

In various embodiments, the display structure 18 further comprises at least one carrying element attached to the first telescoping vertical arm and the second telescoping vertical arm and extending therebetween. For example, the at least one carrying element may be a shelf, a hanger rod of any orientation, for example, parallel or perpendicular to a direction of the at least one track, or a marketing display such as, for example, a picture of a product in use.

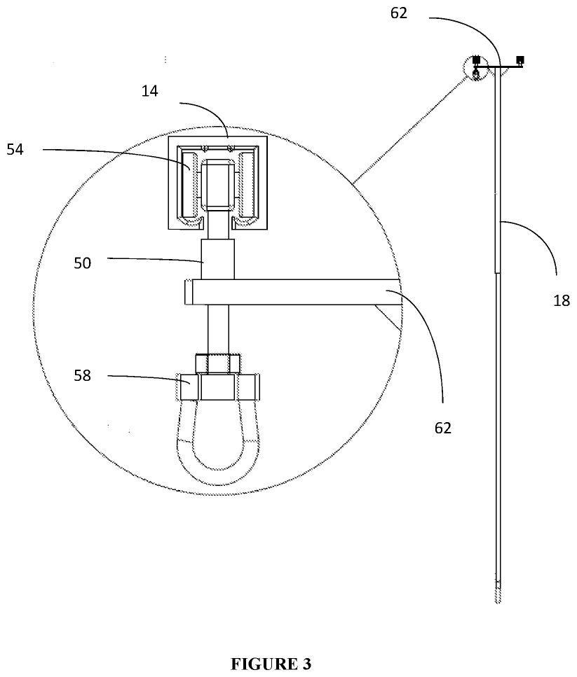

The display structure 18 is slidable along a length of the at least one track 14 and is slidably engaged therewith. In various embodiments, more than one display structure 18 may be slidably engaged with the at least one track 14. The first end of the first telescoping vertical arm and the first end of the second telescoping vertical arm may each comprise a lockable rail element 50 and can independently slidably engage with the at least one track 14, as shown in FIG. 3. The lockable rail element 50 may comprise sliding means 54 for sliding along the least one track 14 and a locking mechanism 58, such as a screw or bolt, for holding the sliding means 54 in a position along the at least one track. For example, the lockable rail element 50 may comprise lockable wheels.

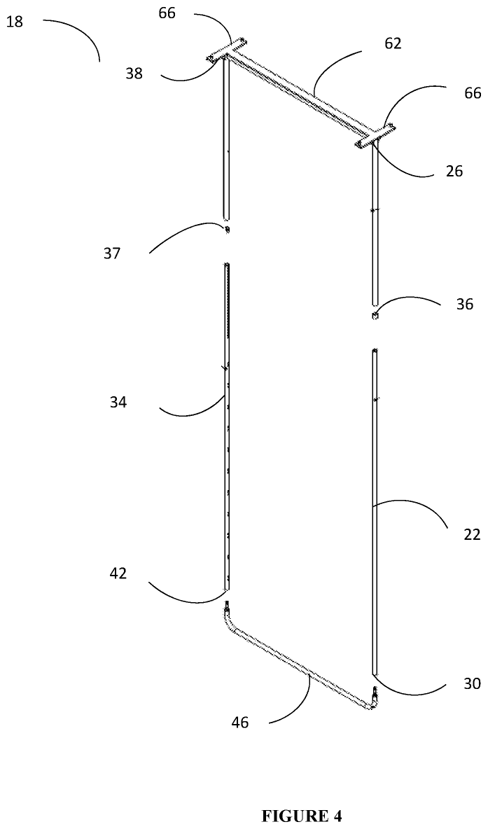

In various embodiments, the at least one track 14 may comprise first 60 and second 61 tracks and the display structure 18 may further comprise a panel 62 attached to the first ends of the first and second telescoping vertical arms and extending therebetween, as shown in FIGS. 1 and 4. The panel 62 may comprise at least two perpendicular cross-arms 66, each having first and second ends. The first and second ends of the at least two cross-arms 66 may each comprise a lockable rail element 50, the lockable rail elements 50 of the first ends slidably engaged with the first track 60 and the lockable rail elements 50 of the second ends slidably engaged with the second track 61.

As shown in FIG. 4, the first telescoping vertical arm 22 may also comprise one or more than one first nylon tubes 36 between each of the bars of the first plurality of bars which act as a washer to enable the first plurality of bars to move relative to another more smoothly. Furthermore, if the first plurality of bars is made, for example, of a finished metal, the nylon tube 36 may act to protect the finish on each bar of the first plurality of bars. Likewise, the second telescoping vertical arm 34 may also comprise one or more than one second nylon tubes 37.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without operator input or prompting, whether these features, elements and/or steps are included or are to be performed in any particular embodiment. No single feature or group of features is required for or indispensable to any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The example calculations, simulations, results, graphs, values, and parameters of the embodiments described herein are intended to illustrate and not to limit the disclosed embodiments. Other embodiments can be configured and/or operated differently than the illustrative examples described herein.

1. An adjustable retail display fixture comprising:
at least one track, the at least one track operably configured to be attached to a wall; and
a display structure slidable along a length of the at least one track and slidably engaged therewith, the display structure comprising:
a first plurality of bars nested one into another forming a first telescoping vertical arm with a first end, a second end and a length, each of the first plurality of bars connected to another with one or more releasable fasteners, the one or more releasable fasteners holding a position of each of the first plurality of bars with respect to another; and
a second plurality of bars nested one into another forming a second telescoping vertical arm with a first end, a second end and a length, each of the second plurality of bars connected to another with one or more releasable fasteners, the one or more releasable fasteners holding a position of each of the second plurality of bars with respect to another,
wherein a height of the display structure is adjustable by adjusting the position of each of the first plurality of bars with respect to another using the one or more releasable fasteners to adjust the length of the first telescoping vertical arm and by adjusting the position of each of the second plurality of bars with respect to another using the one or more releasable fasteners to adjust the length of the second telescoping vertical armₛ
wherein the at least one track comprises first and second tracks and the display structure further comprises a panel attached to the first ends of the first and second telescoping vertical arms and extending therebetween, the panel comprising at least two perpendicular cross-arms having first and second ends, the first and second ends of the at least two cross-arms each comprising a lockable rail element, the lockable rail elements of the first ends slidably engaged with the first track and the lockable rail elements of the second ends slidably engaged with the second track.

2. The adjustable retail display fixture of claim 1, further comprising at least one horizontal bar having a length and attached to the first telescoping vertical arm and the second telescoping vertical arm and extending therebetween.

3. The adjustable retail display fixture of claim 2, wherein the at least one horizontal bar is reversibly attached to the second ends of the first and second telescoping vertical arms.

4. The adjustable retail display fixture of claim 2, wherein the at least one horizontal bar comprises at least two bars nested one into another and connected to another with one or more releasable fasteners.

5. The adjustable retail display fixture of claim 1, further comprising at least one carrying element attached to the first telescoping vertical arm and the second telescoping vertical arm and extending therebetween.

6. The adjustable retail display fixture of claim 1, wherein the first and second telescoping vertical arms each comprise two bars nested one into another and connected with one releasable fastener.

7. The adjustable retail display fixture of claim 1, wherein the first end of the first telescoping vertical arm and the first end of the second telescoping vertical arm each comprise a lockable rail element slidably engaged with the at least one track.

8. (canceled)

9. The adjustable retail display fixture of claim 1, wherein the lockable rail elements comprise lockable wheels.

10. The adjustable retail display fixture of claim 5, wherein the at least one carrying element is a shelf, a hanger rod, or a marketing display.

11. The adjustable retail display fixture of claim 1, wherein more than one display structure is slidably engaged with the at least one track.

12. The adjustable retail display fixture of claim 1, wherein the width of the display structure is static and the height of the display structure is adjustable.

13. The adjustable retail display fixture of claim 1, wherein the one or more releasable fasteners comprise one or more releasable locking pins and each rod of the first and second plurality of rods comprises a plurality of holes along a length of the rod for engaging the one or more releasable locking pins.

14. A display structure for an adjustable retail display fixture, the display structure comprising:
a first plurality of bars nested one into another forming a first telescoping vertical arm with a first end, a second end and a length, each of the first plurality of bars connected to another with one or more releasable fasteners, the one or more releasable fasteners holding a position of each of the first plurality of bars with respect to another; and
a second plurality of bars nested one into another forming a second telescoping vertical arm with a first end, a second end and a length, each of the second plurality of bars connected to another with one or more releasable fasteners, the one or more releasable fasteners holding a position of each of the second plurality of bars with respect to another,
wherein a height of the display structure is adjustable by adjusting the position of each of the first plurality of bars with respect to another using the one or more releasable fasteners to adjust the length of the first telescoping vertical arm and by adjusting the position of each of the second plurality of bars with respect to another using the one or more releasable fasteners to adjust the length of the second telescoping vertical arm,
wherein the display structure further comprises a panel attached to the first ends of the first and second telescoping vertical arms and extending therebetween, the panel comprising at least two perpendicular cross-arms having first and second ends, the first and second ends of the at least two cross-arms each comprising a lockable rail element.

15. The display structure of claim 14, further comprising at least one horizontal bar having a length and attached to the first telescoping vertical arm and the second telescoping vertical arm and extending therebetween,

16. The display structure of claim 15, wherein the at least one horizontal bar comprises at least two bars nested one into another and connected to another with one or more releasable fasteners.

17. The display structure of claim 14, further comprising at least one carrying element attached to the first telescoping vertical arm and the second telescoping vertical arm and extending therebetween.

18. The display structure of claim 14, wherein the first and second telescoping vertical arms each comprise two bars nested one into another and connected with one releasable fastener.

19. (canceled)

20. (canceled)

21. The adjustable retail display fixture of claim 9, wherein each lockable rail element comprises lockable wheels.

22. The display structure of claim 14, wherein each lockable rail element comprises lockable wheels.
